(19) United States
(12) Patent Application Publication
(10) Pub. No.: US 2012/0051220 A1
(43) Pub. Date: Mar. 1, 2012

(54) WIRELESS DEVICE

(75) Inventors: Toshihisa Nabetani, Kanagawa (JP); Kiyoshi Toshimitsu, Tokyo (JP); Masahiro Takagi, Tokyo (JP)

(73) Assignee: KABUSHIKI KAISHA TOSHIBA, Minato-ku, Tokyo (JP)

(21) Appl. No.: 13/131,334

(22) PCT Filed: Nov. 24, 2009
(86) PCT No.: PCT/JP2009/069796

§ 371 Date: Nov. 17, 2011

(30) Foreign Application Priority Data
Nov. 27, 2008 (JP) 2008-302099

(51) Int. Cl. H04W 28/14

(52) U.S. Cl. 370/235

(57) ABSTRACT

A wireless device is capable of transmitting a plurality of frames to the same destination in parallel using a plurality of frequency channels. The wireless device includes: a first transmitter 21 which transmits a frame using a first frequency channel; a second transmitter 22 which transmits a frame using the second frequency channel; and a controller 43 which provides a frame stored in a buffer to the first transmitter if the first frequency channel is determined idle before the second frequency channel is determined idle. The controller 43 provides a frame stored in the buffer to the second transmitter if it is determined that a state that the second frequency channel is idle has continued for a second time before if it is determined that a state that the first frequency channel is idle has continued for a first time. The wireless device configured as above can prevent throughput reduction and suppress the occurrence of a delay beyond an allowable range.

### TECHNICAL FIELD

The present invention relates to a wireless device.

### BACKGROUND ART

IEEE 802.11 which is a typical wireless LAN standard employs, as a wireless access control method, CSMA/CA (carrier sense multiple access with collision avoidance).

In CSMA/CA, a wireless device makes a transmission after confirming by carrier sensing that the medium (frequency channel) has continued to be idle for a prescribed time or more.

A period (carrier sense period) when a wireless device checks medium idleness is the sum of a fixed time (DIES) and a random-length time (random back-off time). The carrier sense period having a random length prevents simultaneous packet transmissions by plural wireless device and hence avoids collisions.

The IEEE 802.11e standard prescribes a QoS (quality of service) function. The IEEE 802.11e standard employs EDCA, in which a carrier sense period is set according to a traffic type (priority rank) of data. This allows a wireless device to preferentially transmit data a traffic type having a high priority rank for which a short carrier sense period is set.

### PRIOR ART DOCUMENTS

### Non-Patent Documents

Non-patent document 1: “Wireless LAN Medium Access Control (MAC) and Physical Layer (PHY) Specifications, Medium Access Control (MAC) Quality of Service (QoS) Enhancements,” IEEE Std. 802.11e-2005.

### SUMMARY OF THE INVENTION

### Problems to be Solved by the Invention

To increase throughput, methods for extending a frequency bandwidth using plural frequency channels have been conceived. For example, a method has been conceived in which transmission rights of respective frequency channels are acquired independently according to CSMA/CA and frames are transmitted on individual frequency channels (multi-channel approach).

However, since the use state (utilization) of each frequency channel varies, the order and the timing of acquisition of transmission rights of respective frequency channels vary each time even if carrier sense periods that are set for the respective frequency channels are the same. Therefore, the order and the timing of transmission of data stored in transmission queues of the respective frequency channels also vary each time. As a result, a wireless device cannot transmit data in order of sequence numbers.

In a reception-side wireless device, when data cannot be received in order of sequence numbers, reception data are output to an upper layer after processing of rearranging the data into sequence number order (re-ordering processing) is performed. Conversely, the data do not reach the upper layer of the wireless device until completion of the re-ordering processing.

As such, in the multi-channel approach, not only does a re-transmission or the like necessitate re-ordering processing but also the time taken by re-ordering processing in a reception-side wireless device is increased even in a new transmission because a transmission-side wireless device does not transmit data in order of sequence numbers, resulting in a problem that the time taken until reaching of data to an upper layer is increased. This problem causes throughput reduction and a delay beyond an allowable range. There is another problem that because re-ordering processing may occur more frequently than before, the capacity of a reception buffer for temporary storage of data needs to be increased.

The present invention has been made in view of the above, and an object of the invention is therefore to provide a wireless device and its control method which can prevent throughput reduction and suppress the occurrence of a delay beyond an allowable range.

### Means for Solving the Problems

In order to achieve the above object, a wireless device according to an embodiment of the present invention is capable of transmitting a plurality of frames to the same destination in parallel using a plurality of frequency channels. The device includes: an attaching section which attaches a series of sequence numbers to the frames, wherein the series of sequence numbers monotonically increase in order of occurrence of transmission requests; a buffer which stores the frames to which the sequence numbers are attached; a first determining section which determines whether or not a state that a first frequency channel is idle has continued for a first time; a second determining section which determines whether or not a state that a second frequency channel is idle has continued for a second time; a first transmitter which transmits a frame using the first frequency channel; a second transmitter which transmits a frame using the second frequency channel; and a controller which provides each of the frames stored in the buffer to one of the first transmitter and the second transmitter. The controller provides, to the first transmitter, a frame to which the smallest sequence number is attached among the frames stored in the buffer if, after the first and second determining sections started to determine, the first determining section determines that a state that the first frequency channel is idle has continued for the first time before the second determining section determines that a state that the second frequency channel is idle has continued for the second time, and the controller provides, to the second transmitter, the frame to which the smallest sequence number is attached among the frames stored in the buffer if, after the first and second determining sections started to determine, the second determining section determines that a state that the second frequency channel is idle has continued for the second time before the first determining section determines that a state that the first frequency channel is idle has continued for the first time

### ADVANTAGES OF THE INVENTION

The invention can prevent throughput reduction and suppress the occurrence of a delay beyond an allowable range.

### BRIEF DESCRIPTION OF THE DRAWINGS

FIG. 1 is a block diagram showing the configuration of a wireless device according to a first embodiment of the present invention.

FIG. 2 is a flowchart of a process which is executed by the wireless device according to the first embodiment of the invention.

FIG. 3 shows frames that are transmitted from the wireless device according to the first embodiment of the invention.

FIG. 4 is a block diagram showing the configuration of a wireless device according to a second embodiment of the invention.

### MODES FOR CARRYING OUT THE INVENTION

Embodiments of the present invention will be hereinafter described.

### Embodiment 1

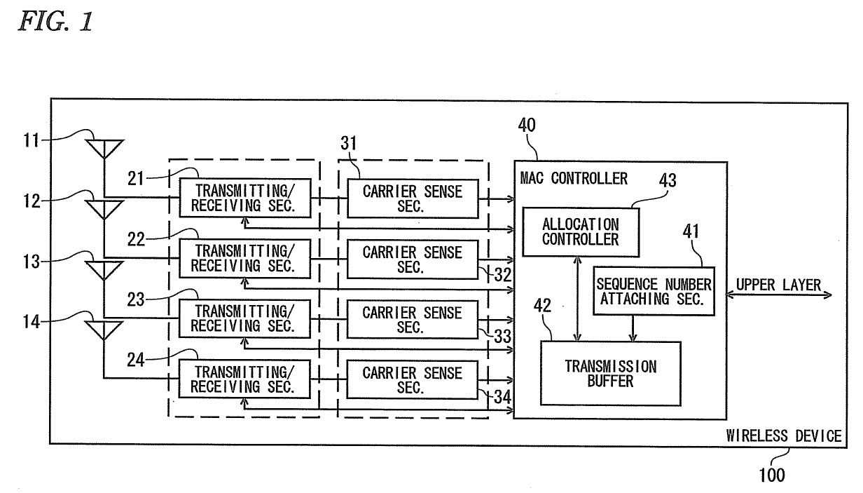

FIG. 1 is a block diagram of a wireless device 100 according to a first embodiment of the invention. Although the wireless device 100 shown in FIG. 1 uses four frequency channels, the number of frequency channels used is not limited to four; satisfactory results are obtained as long as the number of frequency channels is plural.

The wireless device 100 is equipped with antenna units 11-14, transmitting/receiving sections 21-24, carrier sense sections 31-34, and a MAC (media access control) section 40. The MAC controller 40 is provided with a sequence number attaching section 41, a transmission buffer 42, and an allocation controller 43.

The wireless device 100 is equipped with the antenna units 11-14, the transmitting/receiving sections 21-24, and the carrier sense sections 31-34 for respective frequency channels. The antenna units 11-14, the transmitting/receiving sections 21-24, and the carrier sense sections 31-34 of the respective frequency channels operate independently of each other.

The transmitting/receiving sections 21-24 transmit and receive data via the antenna units 11-14 on first to fourth frequency channels, respectively. The transmitting/receiving sections 21-24 perform data transmission/reception processing such as modulation/demodulation processing and AD conversion processing.

The carrier sense sections 31-34 perform pieces of carrier sense processing of the respective frequency channels. Each of the carrier sense sections 31-34 determines whether the frequency channel is busy or idle according to CSMA/CA. If determining that a state that the frequency channel is idle has continued for a prescribed time (carrier sense period), each of the carrier sense sections 31-34 determines that a transmission right for the frequency channel has been acquired. Each of the carrier sense sections 31-34 may check whether the transmission channel is idle or not either continuously or every prescribed time in the carrier sense period.

The MAC controller 40 performs MAC-protocol-related processing.

The sequence number attaching section 41 attaches sequence numbers to data (transmission data) for which transmission requests have been received from an upper layer. The sequence number attaching section 41 attaches a series of sequence numbers for each destination terminal and each data traffic type. For data having the same destination terminal and the same traffic type, the sequence number attaching section 41 attaches sequence numbers (incremented by 1 each time) to the data in order of reception of transmission requests from the upper layer.

The transmission buffer 42 stores (buffers) data to which sequence numbers have been attached by the sequence number attaching section 41. The transmission buffer 42 buffers data until a transmission right for a frequency channel is acquired by one of the carrier sense sections 31-34 and the data is transmitted.

The allocation controller 43 determines on which frequency channels data buffered in the transmission buffer 42 should be transmitted. The allocation controller 43 outputs (allocates) data to one of the transmitting/receiving sections 21-24 that corresponds to a frequency channel for which a transmission right has been acquired by one of the carrier sense sections 31-34.

Although the wireless device 100 is provided with one frequency channel for each set of an antenna unit, a transmission/receiving section, and a carrier sense section, circuit sharing may be done at the time of implementation.

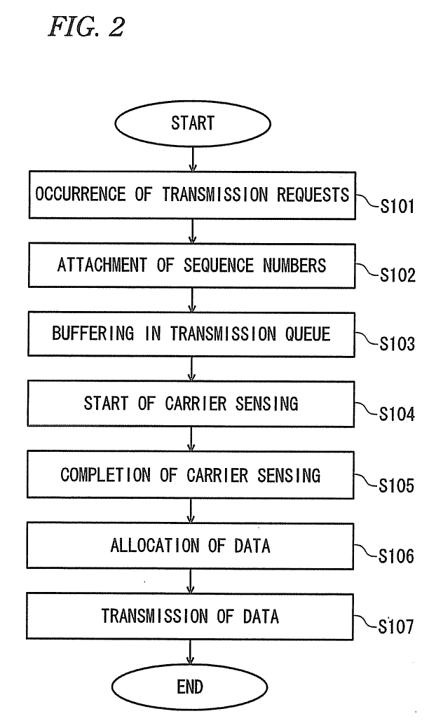

FIG. 2 is a flowchart of a process which is executed by the wireless device 100 in transmitting data. In FIG. 2, it is assumed that the wireless device 100 transmits plural frames to the same destination (another wireless device) parallel on plural frequency channels.

First, data for which transmission requests have been received from an upper layer are input to the MAC controller 40 (step S101).

Then, the sequence number attaching section 41 attaches sequence numbers to the data that have been input to the MAC controller 40 (step S102).

Then, the transmission buffer 42 buffers the data to which the sequence numbers have been attached (step S103).

Then, the MAC controller 40 instructs carrier sense sections of frequency channels to be used for transmissions to start carrier sensing (step S104).

The MAC controller 40 may instruct carrier sense sections of frequency channels to be used for transmissions to start carrier sensing parallel with the attachment of sequence numbers and the data buffering. The MAC controller 40 may determine, in any manner, what frequency channels should be used for transmissions. For example, the MAC controller 40 may determine what frequency channels should be used according to priority ranks that are assigned to the respective frequency channels in advance, or according to channel utilizations of the respective frequency channels (i.e., frequency channels having low channel utilizations are selected preferentially each time). When many data transmission requests have occurred in a short time or many data are buffered in the transmission buffer 42, the MAC controller 40 may instruct carrier sense sections of more frequency channels to start carrier sensing. In the embodiment, the MAC controller 40 can instruct the carrier sense sections 31-34 corresponding to the four frequency channels at the maximum to start carrier sensing independently and parallel. In this example, it is assumed that the MAC controller 40 instructs the carrier sense sections 31-33 (for performing carrier sensing for the first to third frequency channels) to start carrier sensing. The carrier sense sections 31-33 start carrier sensing for the first to third frequency channels via the transmitting/receiving sections 21-23, respectively.

Then, the carrier sense sections 31-33 perform carrier sensing for the first to third frequency channels until an idle state is detected in carrier sense periods (AIFS values plus random back-off times) specified by the MAC controller 40.

The MAC controller 40 may set a carrier sense period in any manner. That is, the MAC controller 40 may set, in any manner, an AIFS value and a contention window (CW) size value (or back-off value) for random back-off. The MAC controller 40 may vary the AIFS value, the CW size value, etc. according to traffic types of data stored in the transmission buffer 42. The MAC controller 40 may set carrier sense periods by setting different AIFS values, CW size values, or the like for the respective frequency channels. The MAC controller 40 may set carrier sense periods for the respective frequency channels according to channel utilizations (busy ratios) of the respective frequency channels. Where the MAC controller 40 instructs the plural carrier sense sections 31-34 simultaneously to start carrier sensing, it may set the same carrier sense period for all the frequency channels. In this case, if no busy state is detected in any frequency channel, transmission rights can be acquired simultaneously for the respective frequency channels and data can be transmitted simultaneously.

Then, detecting that the frequency channel has continued to be idle in the carrier sense period specified by the MAC controller 40, each of the carrier sense sections 31-33 informs the MAC controller 40 that a transmission right for the frequency channel has been acquired (step S105). In this example, it is assumed that first the MAC controller 40 is informed of acquisition of a transmission right for the third frequency channel from the carrier sense section 33 among the carrier sense sections 31-33.

Order of acquisition of transmission rights for the respective frequency channels is not necessarily the same as the order in which the MAC controller 40 gave instructions to start carrier sensing. The MAC controller 40 cannot recognize in what order transmission rights for the respective frequency channels will be acquired until being informed of acquisition of transmission rights for the respective frequency channels by the carrier sense sections 31-34.

Then, after receiving, from the carrier sense section 33, the notice to the effect that the transmission right for the third frequency channel has been acquired, the allocation controller 43 outputs (allocates) the head data buffered in the transmission buffer 42 to the transmitting/receiving section 23 which corresponds to the third frequency channel. Every time the allocation controller 43 receives, from one of the carrier sense section 33, a notice to the effect that a transmission right for the frequency channel has been acquired, it outputs (allocates) the head data buffered in the transmission buffer 42 to the transmitting/receiving section 23 to one of the transmitting/receiving sections 21-23 that corresponds to the transmission-right-acquired frequency channel.

Then, the transmitting/receiving sections 21-23 perform pieces of transmission processing such as modulation processing and D/A conversion processing on the data allocated to them by the allocation controller 43 (step S107). The transmitting/receiving sections 21-23 transmit the transmission-processed data via the respective antennas.

As described above, In the wireless device 100 according to the first embodiment, the allocation controller 43 outputs data to one of the transmitting/receiving sections 21-24 that will transmit data actually only after receiving, from one of the carrier sense sections 31-34, a notice to the effect a transmission right for the frequency channel has been acquired, rather than when transmission requests from the upper layer occur.

That is, when transmission requests from the upper layer have occurred, frequency channels for transmission of the data are not determined in advance and only issuance of instructions to perform carrier sensing for frequency channels that are scheduled to be used for transmission of the data is made. A transmission channel for actual transmission of data concerned is determined when a notice to the effect that a transmission right for a frequency channel has been acquired according to CSMA/CA is received from one of the carrier sense sections 31-34.

Therefore, even in the multi-channel approach in which transmission rights for respective frequency channels are acquired independently and parallel according to CSMA/CA and frames are transmitted on the individual channels, data can be transmitted in order of sequence numbers that are attached for each destination terminal and each data traffic type.

For example, when a transmission request of data (sequence number SN=1) is received from the upper layer, the MAC controller 40 instructs the carrier sense section 31 to start carrier sensing. Furthermore, as transmission requests of data (sequence number SN=2, 3, 4) are received sequentially from the upper layer, the MAC controller 40 sequentially instructs the carrier sense sections 32-34 to start carrier sensing.

If a transmission right for the third frequency channel is acquired earliest, the allocation controller 43 outputs, to the transmitting/receiving section 23 of the third frequency channel, the head data buffered in the transmission buffer 42, that is, the data having the smallest sequence number (SN=1).

With the above configuration, the transmission-side wireless device 100 can transmit data in order of sequence numbers, which is in contrast to the case that when, for example, transmission requests of data (sequence number SN=1, 2, 3, 4) are received sequentially from the upper layer, the first to fourth frequency channels are determined in this order as frequency channels for transmission in advance. This solves the problem that data whose sequence numbers are out of order are transmitted sequentially depending on busy/idle states of the respective frequency channels. That is, a problem that if a transmission right for the third channel is acquired earliest, data of SN=3 is transmitted before data of SN=1.

In a reception-side wireless device, re-ordering processing can be performed smoothly. As a result, the delay in the timing of transfer of received data from the reception-side wireless device to an upper layer can be reduced, whereby the probabilities of occurrence of throughput reduction and a delay beyond an allowable range can be lowered. The risk of a buffer overflow of a reception buffer which is used for re-ordering processing can be lowered and the necessary size of the reception buffer can be reduced.

<Case that Transmission Rights for Plural Frequency Channels are Acquired Simultaneously>

When receiving, simultaneously, from the plural carrier sense sections 31-34, notices to the effect that a transmission right for a frequency channel has been acquired, the allocation controller 43 allocates data buffered in the transmission buffer 43 to the transmitting/receiving sections 21-24 according to the following rules (step S106 in FIG. 2). Either one of the first to third rules or a combination of plural ones of them may be used.

### (First Rule)

The allocation controller 43 allocates data buffered in the transmission buffer 43 according to predetermined (fixed) priority ranks of the respective frequency channels. The allocation controller 43 allocates data arranged from the head of the transmission buffer 42 to plural frequency channels for which transmission rights have been acquired, one by one in descending order of priority ranks. According to this rule, data having small sequence numbers are transmitted on frequency channels having high priority ranks.

### (Second Rule)

The allocation controller 43 allocates data according to channel utilizations of the respective frequency channels. The allocation controller 43 allocates data arranged from the head of the transmission buffer 42 to plural frequency channels for which transmission rights have been acquired, one by one in ascending order of channel utilizations. The channel utilization means the ratio of a period in which a determination “busy” is made to a period in which carrier sensing is performed. As for channel utilization estimation, a channel utilization may be calculated continuously from the start of a network or activation of a subscription to a network, calculated (updated) every prescribed period (e.g., beacon interval period), or calculated (updated) every time the number of data transmissions (or receptions) reaches a prescribed number. The smaller the channel utilization, the lower the probability that a frame contention occurs when data is transmitted. Therefore, this rule which allows data having small sequence numbers to be transmitted on frequency channels having small channel utilizations makes it possible to lower the contention probability when data having a small sequence number is transmitted, and to thereby increase the probability that data are transmitted in order of sequence numbers.

### (Third Rule)

The allocation controller 43 allocates data according to frame error ratios of the respective frequency channels. The allocation controller 43 allocates data arranged from the head of the transmission buffer 42 to plural frequency channels for which transmission rights have been acquired, one by one in ascending order of frame error ratios. A frame error ratio may be calculated continuously from the start of a network or activation of a subscription to a network, calculated (updated) every prescribed period (e.g., beacon interval period), or calculated (updated) every time the number of data transmissions (or receptions) reaches a prescribed number. This rule which allows data having small sequence numbers to be transmitted on frequency channels having small frame error ratios makes it possible to transmit data having small sequence numbers on frequency channels whose propagation path characteristics are good, which in turn makes it possible to lower the probability of occurrence of a re-transmission and to increase the probability that data are transmitted in order of sequence numbers.

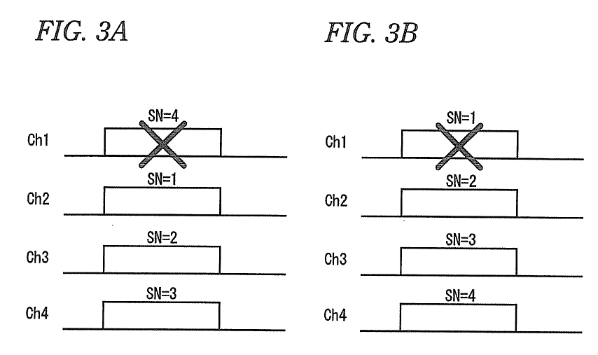

FIGS. 3(a) and 3(b) illustrate an advantage that is obtained by the allocation controller 43's allocating data according to the first to third rules. FIGS. 3(a) and 3(b) show examples corresponding to a case that transmission rights for the four frequency channels have been acquired simultaneously. It is assumed that the priority rank of the frequency channel decreases (the channel utilization or the frame error ratio increases) in order of the second one, third one, fourth one, and first one (priority order of the frequency channels: Ch2>Ch3>Ch4>Ch1).

FIG. 3(a) shows transmission frames of a case that the allocation controller 43 allocates data according to the first to third rules. FIG. 3(b) shows transmission frames of a case that the allocation controller 43 simply allocates data arranged in ascending order of sequence numbers to the frequency channels in ascending order of channel numbers. It is assumed that in each of the examples of FIGS. 3(a) and 3(b) a transmission of data on the first frequency channel Ch1 which is lowest in priority rank (largest in channel utilization or frame error ratio) fails.

In the example of FIG. 3(a), the reception-side wireless device can receive the data of SN=1, 2, and 3 correctly in the first transmissions. Therefore, it is found in re-ordering processing that the received data are arranged in order of sequence numbers (i.e., there is no lack of data), and the received data SN=1, 2, and 3 can be transferred to an upper layer immediately. That is, a delay due to the re-ordering processing can be minimized.

In the example of FIG. 3(b), in the first transmissions, the reception-side wireless device can receive the data of SN=2, 3, and 4 correctly but cannot receive the data of SN=1 correctly. It is found in re-ordering processing that the received data are not arranged in order of sequence numbers. Therefore, the correctly received data of SN=2, 3, and 4 are buffered in the reception buffer without being transferred to the upper layer, and waiting is done until the data of SN=1 is received by correctly by a re-transmission.

In the example of FIG. 3(b), even if data of SN=5 and ensuing data are received correctly, the data of SN=2, 3, and 4 cannot be transferred to the upper layer and kept buffered in the reception buffer. This results in problems of throughput reduction due to the delay in the timing of transfer to the upper layer, non-satisfaction of a delay request, and risk of a buffer overflow of the reception buffer.

As described above, since the allocation controller 43 allocates data according to the first to third rules, in a reception-side wireless device received data can be transferred to an upper layer immediately and a delay due to re-ordering processing can be minimized. As a result, throughput reduction can be prevented and the occurrence of a delay beyond an allowable range can be suppressed.

### Embodiment 2

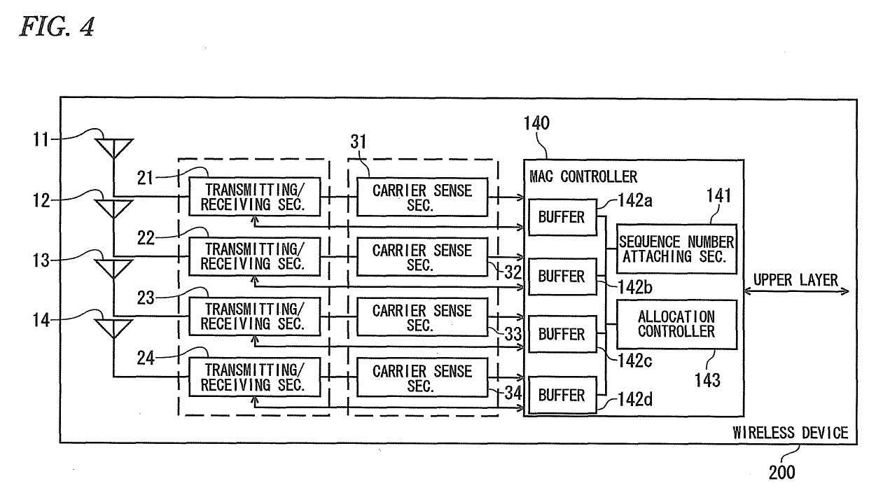

FIG. 4 is a block diagram of a wireless device 200 according to a second embodiment of the invention.

The wireless device 200 is different from the wireless device 100 according to the first embodiment in a MAC controller 140. The MAC controller 140 is equipped with, in addition to a sequence number attaching section 141 and an allocation controller 143, transmission buffers 142a-142d which are provided for respective frequency channels. Sections etc. having the same ones in the wireless device 100 according to the first embodiment will be given the same reference symbols as the latter and will not be described in detail.

The sequence number attaching section 141 attaches sequence numbers to data (transmission data) for which transmission requests have been received from an upper layer. The sequence number attaching section 141 stores data to which sequence numbers have been attached by the sequence number attaching section 41. The transmission buffer 42 buffers each sequence-number-attached data in one of the transmission buffers 142a-142d which correspond to first to fourth frequency channels, respectively. The MAC controller 140 may determine, in any manner, in transmission buffers corresponding to which frequency channels the data should be stored.

At the same time as stores transmission data in a transmission buffer, the MAC controller 140 instructs the carrier sense section of the corresponding frequency channel to start carrier sensing.

Each of the transmission buffers 142a-142d continues to buffer data until the corresponding one of the carrier sense sections 31-34 acquires a transmission right for the frequency channel and the data is transmitted.

The allocation controller 143 determines on which frequency channels the data buffered in the transmission buffers 142a-142d should be transmitted. The allocation controller 143 outputs (allocates) data to one of the transmitting/receiving sections 21-24 that corresponds to a frequency channel for which a transmission right has been acquired by one of the carrier sense sections 31-34.

It is now assumed that data having the smallest sequence number (SN=1) is buffered in the transmission buffer 142a which corresponds to the first frequency channel. At the same time as the data of SN=1 is buffered, the carrier sense section 31 starts carrier sensing for the first frequency channel. However, even in a case that the other carrier sense sections 32-34 start carrier sensing for the second to fourth frequency channels after the carrier sense section 31 started carrier sensing for the first frequency channel, it is probable that a transmission right for another frequency channel (e.g., third frequency channel) is acquired before acquisition of a transmission right for the first frequency channel.

In this case, the allocation controller 143 outputs (allocates) the data of SN=1 buffered in the transmission buffer 142a which corresponds to the first frequency channel, to the one, corresponding to the transmission-right-acquired third frequency channel, of the transmitting/receiving sections 21-24.

With the above configuration, even in the case where the transmission buffers 142a-142d corresponding to the respective frequency channels are provided, the wireless device 200 can transmit data in order of ascending order of sequence numbers on frequency channels for which transmission rights are acquired sequentially. That is, data can be transmitted from the transmission-side wireless device 200 in order of sequence numbers.

The invention is not limited to the above embodiments themselves and, in the practice stage, may be embodied in such a manner that constituent elements are modified without departing from the spirit and scope of the invention. And various inventions can be conceived by properly combining plural constituent elements disclosed in each embodiment. For example, several ones of the constituent elements of each embodiment may be omitted. Furthermore, constituent elements of different embodiments may be combined as appropriate.

### DESCRIPTION OF SYMBOLS

100, 200 . . . Wireless device
11, 12, 13, 14 . . . Antenna unit
21, 22, 23, 24 . . . Transmitting/receiving section
31, 32, 33, 34 . . . Carrier sense section
40, 140 . . . MAC controller
41, 141 . . . Sequence number attaching section
42, 142a, 142b, 142c, 142d . . . Transmission buffer
43, 143 . . . Allocation controller

1. A wireless device capable of transmitting a plurality of frames to the same destination in parallel using a plurality of frequency channels, the device comprising:
an attaching section which attaches a series of sequence numbers to the frames, wherein the series of sequence numbers monotonically increase in order of occurrence of transmission requests;
a buffer which stores the frames to which the sequence numbers are attached;
a first determining section which determines whether or not a state that a first frequency channel is idle has continued for a first time;
a second determining section which determines whether or not a state that a second frequency channel is idle has continued for a second time;
a first transmitter which transmits a frame using the first frequency channel;
a second transmitter which transmits a frame using the second frequency channel; and
a controller which provides each of the frames stored in the buffer to one of the first transmitter and the second transmitter,
wherein the controller provides, to the first transmitter, a frame to which the smallest sequence number is attached among the frames stored in the buffer if, after the first and second determining sections started to determine, the first determining section determines that a state that the first frequency channel is idle has continued for the first time before the second determining section determines that a state that the second frequency channel is idle has continued for the second time, and
wherein the controller provides, to the second transmitter, the frame to which the smallest sequence number is attached among the frames stored in the buffer if, after the first and second determining sections started to determine, the second determining section determines that a state that the second frequency channel is idle has continued for the second time before the first determining section determines that a state that the first frequency channel is idle has continued for the first time

2. The wireless device of claim 1, further comprising:
a generator which generates transmission requests for the frames,
wherein the first determining section starts to determine whether or not a state that the first frequency channel is idle has continued for the first time in response to a transmission request for a first frame generated by the generator, and then
the second determining section starts to determine whether or not a state that the second frequency channel is idle has continued for the second time in response to a transmission request for a second frame generated by the generator,
wherein the controller provides the first frame stored in the buffer to the second transmitter if the second determining section determines that a state that the second frequency channel is idle has continued for the second time before a state that the first frequency channel is idle has continued for the first time.

3. The wireless device of claim 1,
wherein a first priority rank is set to the first frequency channel,
wherein a second priority rank higher than the first priority rank is set to the second frequency channel,
wherein the buffer stores a plurality of frames therein, and
wherein if the first determining section determines that a state that the first frequency channel is idle has continued for the first time at the same time as the second determining section determines that a state that the second frequency channel is idle has continued for the second time, the controller provides a frame to which a smaller sequence number is attached, to the second transmitter which transmits a frame using the second frequency channel having the higher priority rank between the first frequency channel and the second frequency channel.

4. The wireless device of claim 1,
wherein a frame error ratio of the first frequency channel has a first value,
wherein a frame error ratio of the second frequency channel has a second value that is smaller than the first value,
wherein the buffer stores a plurality of frames therein, and
wherein if the first determining section determines that a state that the first frequency channel is idle has continued for the first time at the same time as the second determining section determines that a state that the second frequency channel is idle has continued for the second time, the controller provides a frame to which a smaller sequence number is attached, to the second transmitter which transmits a frame using the second frequency channel having the smaller frame error ratio between the first frequency channel and the second frequency channel.

5. The wireless device of claim 1,
wherein a channel utilization of the first frequency channel has a first value,
wherein a channel utilization of the second frequency channel has a second value that is smaller than the first value,
wherein the buffer stores a plurality of frames therein, and
wherein if the first determining section determines that a state that the first frequency channel is idle has continued for the first time at the same time as the second determining section determines that a state that the second frequency channel is idle has continued for the second time, the controller provides a frame to which a smaller sequence number is attached, to the second transmitter which transmits a frame using the second frequency channel having the smaller channel utilization between the first frequency channel and the second frequency channel.
